(19) United States
(12) Patent Application Publication
(10) Pub. No.: US 2018/0077883 A1
(43) Pub. Date: Mar. 22, 2018

(54) HYDROPONICS GROWING MEDIUM

(71) Applicants: KNAUF INSULATION, INC., Shelbyville, IN (US); KNAUF INSULATION SPRL, Vise (BE)

(72) Inventors: Roger JACKSON, St. Helens (GB); Tony AINDOW, St. Helens (GB); George BAYBUTT, St. Helens (GB)

(21) Appl. No.: 15/822,754

(22) Filed: Nov. 27, 2017

Related U.S. Application Data
(63) Continuation of application No. 15/625,587, filed on Jun. 16, 2017.
Application No. 15/625,587 is a continuation of application No. 15/398,210, filed on Jan. 4, 2017, now abandoned.
Application No. 15/398,210 is a continuation of application No. 15/217,556, filed on Jul. 22, 2016, now abandoned.
Application No. 15/217,556 is a continuation of application No. 12/524,469, filed on Nov. 12, 2009, now abandoned.

(51) Int. Cl. A01G 31/00

(52) U.S. Cl. CPC A01G 31/001; A01G 2031/005

(57) ABSTRACT

A hydroponics growing medium comprising mineral fibres and an organic binder, the growing medium has a Weathered Interlaminar Strength of at least 4 kilopascals and a phenol content of less than or equal to 0.01% by weight.

This invention relates to a mineral fibre product, particularly for hydroponics applications and particularly having a low phenol or phenol free binder.

Industry standard binders used for mineral fibre products, for example of glass wool and rock wool, are based on phenol formaldehyde resins. Such binders are required to hold the mineral fibres together in the form of a mat or block.

The presence of a binder in a hydroponics growing medium may be detrimental to plant growth, particularly due to the presence and/or release of phenol. However, in the water soaked hydroponics growing conditions, the presence of a binder is necessary to keep the mineral fibres bound together.

According to one aspect, the present invention provides a hydroponics growing medium as defined in claim 1. Other aspects are defined in other independent claims. Preferred and/or alternative features are defined in the dependent claims.

The Weathered Interlaminar Strength gives an indication of the ability of the growing medium to remain in tact as a block or mat when in contact with irrigation water in plant growing conditions. The Weathered Interlaminar Strength may be greater than 5 kilopascals; this may allow the growing medium to have sufficient physical integrity to be used for more than one or even more than two growing cycle rather than being discarded after a single use.

The low (preferably zero) phenol content may provide a. better plant growing environment, particularly in the seedling or early part of the plant growing cycle. The growing medium may be phenol free or substantially phenol free; preferably the binder is phenol free or substantially phenol free.

As used herein, reference to phenol content is in terms of the presence of free phenol and/or low molecular weight phenol; the term phenol free means that there is substantially no free phenol or low molecular weight phenol present and preferably less than one part per million by weight.

The phenol content may be measured by gas chromatography.

Preferably, the hydroponics growing medium of the present invention provides for improved plant vigour when compared with know mineral fibre growing mediums, particularly those having phenol contents greater than the present invention. Plant vigour may be assessed in a comparative growing test, for example with cucumber plants (cultivar aviance) sown in 10 cm×10 cm×6.5 cm of hydroponics mineral wool blocks and grown in controlled hydroponics conditions. Leaf size 31 days and/or 42 days after sowing may be used as an indication of plant vigour, preferably using statistical analysis. The growing conditions for such a test preferably include:
Controlled glass house conditions
Supplementary lighting for 16 hours per day between 0400 and 2000 hours
Watering once a day with nutrients applied in the irrigation water
Growing cubes grouped together for the first 20 days and then re-spaced at approximately 25 cm centres; subsequently re-spaced twice before being strung on supporting wires after 38 days from sowing, the positions of the plants being changed each time they are re-spaced or strung to reduce positional effects.
glasshouse temperature initially set at 24° C. until first spacing and then reduced to 23° C., with ventilation 1° C. above the set points

The nature of the binder may allow increased binder contents, for example of 4% by weight or more, to be used without having an adverse effect upon plant growth. The binder content may be greater than or equal to 4.5%, 5%, 5.5%, 6%, 6.5%, 7%, 7.5%, 8% or 9% by weight. The binder content is expressed as a weight % when cured in the growing medium as ready for use and may be measured and/or expressed as loss on ignition. The loss on ignition is expressed as a percentage calculated from (weight loss on ignition i.e. weight of binder)/total weight before ignition.

The binder may:
be based on a reducing sugar; and/or
be based on reductosis; and/or
be based on an aldehyde containing sugars/and/or
include at least one reaction product of a carbohydrate reactant and an amine reactant; and/or
include at least one reaction product of a reducing sugar and an amine reactant; and/or
include at least one reaction product of a carbohydrate reactant and a polycarboxylic acid ammonium salt reactant; and/or
include at least one reaction product from a Maillard reaction.

The binder may be based on a combination of a polycarboxylic acid, for example citric acid, a sugar, for example dextrose, and a source of ammonia, for example ammonia solution. It may be based on a combination of ammonium citrate and dextrose. Where the binder is based on sugars and/or citric acid and or comprises significant —OH groups, it is particularly surprising that such levels of Weathered Interlaminar Strength can be achieved. It would have been thought that the —OH groups for example in the sugars and/or citric acid would be readily subject to hydrolysis and that the binder would consequently loose significant strength in wet or humid conditions. The properties of the present invention are also surprising as traditionally proposed polyester based binder systems are generally regarded as being susceptible to hydrolysis and so lacking in mechanical performance under wet or humid conditions.

The binder may comprise a silicon containing compound, particularly a silane; this may be an amino-substituted compound; it may be a silyl ether; it may facilitate adherence of the binder to the mineral fibres.

The binder may comprise melanoidins; it may be a thermoset binder; it may be thermally curable.

The binder may be one of those disclosed in International patent application no PCT/US2006/028929, the contents of which is hereby incorporated by reference.

Deriving the binder from or essentially from natural and/or sustainable raw materials, that is to say for example crops, plants or products derived therefrom as opposed for example to petrochemicals, may reduce the risk of introducing potentially undesirable compounds in to the growing medium; it may also be ecologically desirable.

The mineral fibres are preferably rock wool; they may be glass wool. They are preferably crimped; they may have an average diameter between 2 and 9 microns.

The growing medium may have
a nominal thickness in the range 50-100 mm; and/or
a density in the range 30-100 kg/m³, particularly 50-80 kg/m³

A non-limiting example of the invention is described below.

An aqueous binder was prepared by mixing together:

| | Approximate % by weight |
|---|---|
| Powdered dextrose monohydrate | 29.8% |
| Powdered anhydrous citric acid | 5.3% |
| 28% aqueous ammonia | 6.0% |
| Silane A-1100 | 1.0% |
| Surfactant | 6.2% |
| Water | 52.5% |

This phenol free binder was used in the manufacture of a growing medium of rock wool on a standard rock wool manufacturing line, the binder being sprayed onto the fibres just after fiberising and the coated fibres being collected, assembled in to a mat, compressed and cured in the usual way.

The phenol free growing medium had:
a binder content of about 5% by weight as determined by loss on ignition
a thickness of about 65 mm
a density of about 75 kg/m³

Desired characteristics and results achieved are set out in Table 1:

TABLE 1

| | | Accep- | | More | Most | |
|---|---|---|---|---|---|---|
| | | tance | Pre- | Pre- | pre- | Result |
| | Units | limit | ferred | ferred | ferred | achieved |
| Weathered | Kilopascals | ≥4 | ≥5 | ≥7.5 | ≥10 | 9.2 |
| Interlaminar | | | | | | |
| strength | | | | | | |

### Testing of Weathered Interlaminar Strength:

The test is carried out on mineral fibre mats which have been subjected to the following accelerated weathering procedure: five samples to be tested are placed in a preheated autoclave and conditioned on a wire mesh shelf away from the bottom of the chamber under wet steam at 35 kN/m² for one hour. They are then removed, dried in an oven at 100° C. for five minutes and tested immediately for interlaminar strength.

The interlaminar strength is the tensile strength of the mineral fibre material in the direction substantially perpendicular to the principle plane in which the fibres have been deposited or are orientated. It is determined in accordance with European Standard EN1607 of November 1996 (incorporated herein by reference) with the following details and/or variations:
the thickness of the samples is the thickness as commercialized
the dimensions of the faces secured to the tensile testing machine are preferably 100 mm×150 mm; samples having these dimensions are cut from the hydroponics growing medium as commercialized. Smaller dimensions may be used if the hydroponics growing medium is only commercialized in smaller dimensions.
The adhesive used to secure the samples to the testing apparatus is preferably a hot melt adhesive

The interlaminar strength is calculated as the mean average of the tensile strength of the five samples tested.

1. A hydroponics growing medium comprising mineral fibres and an organic binder, the growing medium having a Weathered Interlaminar Strength of at least 4 kilopascals and a phenol content of less than or equal to 0.01% by weight.

2. A hydroponics growing medium in accordance with claim 1, in which the Weathered Interlaminar Strength is at least 5 kilopascals.

3. A hydroponics growing medium in accordance with claim 1, in which the phenol content is less than 0.005 by weight, preferably less than 0.001% by weight.

4. A hydroponics growing medium in accordance with claim 1, in which the binder is substantially phenol free.

5. A hydroponics growing medium in accordance with claim 1, in which the binder content is in the range 2 to 10% by weight.

6. A hydroponics growing medium in accordance with claim 1, in which the binder content is greater than 4% by weight.

7. A hydroponics growing medium in accordance with claim 1, in which the binder is based on a reducing sugar.

8. A hydroponics growing medium in accordance with claim 1, in which the binder comprises at least one Maillard reaction product.

9. A hydroponics growing medium in accordance with claim 1, in which the binder is based on reaction products obtained by curing an aqueous solution comprising citric acid, ammonia and dextrose.

10. A hydroponics growing medium in accordance with claim 1, in which the binder is derived essentially from natural and/or sustainable raw materials.

11. A hydroponics growing medium comprising mineral fibres and an organic binder, the growing medium having a Weathered Interlaminar Strength of at least 4 kilopascals and the binder being derived essentially from natural and/or sustainable raw materials.

12. A plant grown in a hydroponics growing medium according to claim 1.

13. Use of a mineral fibre product comprising mineral fibres and an organic binder and having a Weathered Interlaminar Strength of at least 75 g/g and a phenol content of less than or equal to 0.01% as a hydroponics growing medium.
